(19) United States
(12) Patent Application Publication
(10) Pub. No.: US 2024/0356359 A1
(43) Pub. Date: Oct. 24, 2024

(54) TC zero-current switching battery charger, TC+TC zero-current switching bidirectional charger and active DC transformer

(71) Applicant: Bingyao Zhang, Tianjin (CN)

(72) Inventors: Bingyao Zhang, Tianjin (CN); Peixing Zhang, Tianjin (CN)

(21) Appl. No.: 18/586,474

(22) Filed: Feb. 24, 2024

(30) Foreign Application Priority Data
Jun. 21, 2023 (CN) 202310747407.X

(51) Int. Cl. H02J 7/06

(52) U.S. Cl. CPC H02J 7/06; H02J 2207/20

(57) ABSTRACT

A phase-shifted full-bridge DC/DC converter supported by the patent number U.S. Pat. No. 10,050,544B2 cancels the controllable saturation inductor L_{K} and replaces the CDR buffer circuit with the energy storage capacitor C_{S}, resulting in a TC zero composed of the transformer T₁ and the energy storage capacitor C_{S} as core components. Current commutation, seamless docking soft switching battery charger. The mirror method is used to modify it to form a CTC and TC+TC bidirectional charger. The maintenance and switching of the charging direction only need to use a set of triggers and rely on the difference in battery voltage on both sides to complete the task autonomously.

### BACKGROUND OF THE PRESENT INVENTION

### Field of Invention

It has been proven by practice that alternating current is the forerunner of direct current. To establish a DC microgrid, the stability of the bus voltage of the power supply system and the prevention of power outages are key technologies. Consequently, a low-voltage power storage system needs to be established, which forms a power exchange platform with the high-voltage bus, and needs to be connected to a bidirectional DC/DC converter. When the energy on the bus voltage side is sufficient, the energy is sent to the low-voltage storage system through the converter and stored to suppress the increase in bus voltage; when the energy is insufficient, the low-voltage storage system releases the stored energy to maintain the stability of the bus voltage, forming a DC microgrid, so as to provide guarantee for the balance of power supply and demand. This bidirectional DC converter and active DC transformer, which maintains the stability of the bus voltage by charging and discharging the low-voltage storage system, is a necessary bidirectional charger for building a DC microgrid. It is also called a DC microgrid bus voltage regulator. Once a vicious power outage occurs in the bus test, electric vehicles equipped with the bidirectional charger supported by this patent can serve as mobile power stations to provide V2G vehicle and network interactive functional services to ensure the safe operation of the power grid.

### Description of Related Arts

In the process of successfully developing a high-power phase-shifted full-bridge battery charger above 30 KW, the patent “Ultra-high power ZVS+ZCS integrated soft-switching DC/DC converter” was obtained, with a publication number of U.S. Pat. No. 10,050,544 B2, which is called the former patent in latter. It supports high-power phase-shifted full-bridge battery chargers. The DC bus voltage V_{S} supplies power to the two bridge arms of the phase-shifted full bridge composed of four IGBT switches, the Q₁Q₃ leading arm and the Q₄Q₂ lagging arm. The controllable saturation inductor L_{K}=L_{K1}+L_{K2} is not connected with the midpoints X and Y any longer, but directly connected with the primary coil N₁ of transformer T₁. The secondary coil N₂ is connected to the snubber circuit C_{DR} composed of C_{S1} D₉C_{S2}D₁₀D₁₁R₁R₂ through the rectifier bridge and then connected to the L_{F}C₁ filter circuit to obtain the DC voltage V₀, which is connected to the battery load Z₀, which is as shown in FIG. 1. The equivalent circuit is shown in FIG. 2, using the leakage inductance L_{σ1} of the original coil N₁, the mutual inductance or magnetizing inductance Lₘ, and the leakage inductance L_{σ2} of the coil N₂ to represent the transformer. FIG. 3 is the main node waveform diagram during runtime.

t<t₁, during the later period of energy transmission, there is electromagnetic induction. Take the D pulse triggering Q₃ and the A pulse triggering Q₄ to turn on as an example. The bus voltage V_{S} provides a load current refraction value I₀′ and the excitation current I_{M} to the transformer T₁ coil N₁; I₁=I₀′+I_{M}. The excitation current I_{M} is configured to establish electromagnetic induction and maintain the balance of the magnetic potential and voltage on both sides of the transformer. That is, the current on both sides is inversely proportional to the number of turns of the coil

$${I}_{0} ’ = \frac{N 2}{N 1} {I}_{0} ,$$

and the induced voltage (V_{ST}) on both sides is proportional to the number of turns

$$\frac{V 1}{V 2} = \frac{N 1}{N 2} .$$

Ignoring the voltage drops of the leakage inductances L_{σ1} and L_{σ2} of the coils N₁ and N₂, then V_{S}=V_{XY}=V_{ST}, and the load current I₀ is sent to the load Z₀ with a slope

$$\frac{dio}{dt} \begin{matrix} \\ =\end{matrix} \frac{{V}_{st} - {V}_{σ}}{LF}$$

voltage V₀ obtained through the L_{F}C₁ filter circuit.

t₁,(t₁+Δt_{cd})˜t₂,(t₂+Δt_{ab})˜t₃ commutation time of the two bridge arms. When t=t1, under the control of voltage or current negative feedback, the super forearm starts to commutate first, turning off pulse D and switch tube Q3. The leakage inductance L_{σ1} of the primary coil N₁ resonates with the body capacitance C_{P3} of the switching tube. The voltage drop of the Q₃ tube increases, which raises the node Y potential and the transformer voltage drops. On the secondary side, the filter inductor L_{F} maintains continuous flow, which is the load current I₀, and the buffer capacitor C_{S1}C_{S2} discharges in parallel. Due to electromagnetic induction, the voltage on both sides of the transformer suddenly drops by nearly half. Then the capacitor discharges, the voltage drops slowly, and the rectifier bridge diode is blocked due to inversion, the refraction current I₀′=0, I₁=I_{M}. When t=t₁+Δt_{cd}, pulse C triggers Q₁ to turn on, the transformer voltage drops to 0, the excitation current disappears I_{M}=0, the transformer loses electromagnetic induction, the primary voltage V_{XY} and current I₁ enter the 0 period, and the super forearm commutation changes starts from 0 load current and ends at 0 excitation, the energy stops transmitting. This 0 current commutates, and a square wave trailing edge current is obtained. When t=t₂, the lagging arm Q₄Q₂ maintains 0 current commutation. When t=t₂+Δt_{ab}, pulse B triggers the Q₂ tube to conduct, the transformer reverses direction, and the voltage equation

$${V}_{s} = - {V}_{xy} = - {L}_{σ 1} \frac{dI 1}{dt}$$

is established.

The leakage inductance L_{σ1} supports the bus voltage, increases the current from 0, and establishes the current slope

$$\frac{dI 1}{dt} = \frac{V S}{L σ 1} ,$$

when t=t₃, the load current refraction value I₁=I₀ is reached, the square wave leading edge current is obtained. The two arms are commutated with 0 current, and the super forearm is commutated with 0 load current with excitation current.

t₃˜t₄˜t₅ restores electromagnetic induction and continues to transmit energy. After t₃, the primary side will continue to provide current, which is the excitation current I_{M}. Because the magnetic permeability of the magnetic core is very high and the I_{M} value is very small, the primary side current I₁=I₀′+Iₘ, the coils on both sides of the transformer will induce mutual inductance potential, that is, voltage V_{ST}. The electromagnetic induction

$${I}_{0} ’ = \frac{N 2}{N 1} {I}_{0}$$

also induces the refracted current to the secondary side. The voltage V_{ST} is rectified after passing through the leakage inductance L_{σ2}, and the buffer circuit C_{DR}, i.e., the capacitor C_{S1}C_{S2} circuit is connected in series through D₉ and the additional attenuation resistor R₁R₂ circuit. If the voltage is added to the inductor, the capacitor circuit, since the capacity of the capacitor is very small at this time and the voltage is already zero, it must recharge the capacitor in an oscillating manner, generating a pulsating voltage close to 2 times of V_{ST}, and the charging current is superimposed on the load current I₀ to form a peak current, t=t₄ replaces the freewheeling flow into the filter inductance L_{F}, and then connects with the freewheeling filter inductance L_{f}, that is, the load current I₀, and then be sent to the load with the equation

$$\frac{dio}{dt} \begin{matrix} \\ =\end{matrix} \frac{{V}_{st} - {V}_{σ}}{LF}$$

slope until t=t₅. The negative feedback turns off the pulse C and the switching tube Q₁, and the super-forearm starts commutating again, similar to the aforementioned t=t₁ working process. As can be seen from FIG. 3, the two arms commutate starting from t₁ to restore electromagnetic induction. The continuous transmission of energy realizes the oscillatory docking of the voltage and current parameters on both sides of the transformer, and keeps the two parameters in the same phase to ensure no reverse power transmission, in such a manner that the seamless connection of current and voltage is obtained.

### SUMMARY OF THE PRESENT INVENTION

In view of this, the problem to be solved by the present invention is to provide a TC zero-current switch battery charger and a TC+TC zero-current switch bidirectional charger.

In order to solve the above technical problems, the technical solutions adopted in the present invention are: TC zero-current switch battery charger and TC+TC zero-current switch bidirectional charger.

In the zero-current switching charger supported by the previous patent, the controllable saturation inductor L_{K}=L_{K1}+L_{K2} connected at the midpoints X and Y of the two bridge arms is cancelled, and adopting a large enough energy storage capacitor C_{S} to replace the buffer circuit C_{DR} (consisting of C_{S1}, D₉, C_{S2}, D₁₀, D₁₁, R₁, R₂), with transformer T₁ and energy storage capacitor C_{S} as the core components to form a phase-shifted full-bridge TC zero-current switching charger, as shown in FIG. 4.

When t=t₁, the super forearm starts to commutate first. On the secondary side of the transformer, the energy storage capacitor C_{S} changes from charging to discharging with the load current I₀. Because the capacitor capacity is large enough, the voltage drops slowly, and the voltage drop on the primary side of the transformer is accomplished by resonance causing the diode clamp V_{S} in Q₁, thus blocking the refraction of the load current to the primary side, when t=t₁+Δt_{cd}, the current returns to 0 to stop energy transmission, see time-sharing structure FIGS. 5-1 and 5-2. When t=t₂, the lagging arm begins to commutate with zero current, and when t=t+Δt_{ab}, transformer applies the bus voltage in the reverse direction. The voltage equation

$${V}_{s} = - {V}_{xy} = - {L}_{σ 1} \frac{dI 1}{dt}$$

is obtained. With the leakage inductance L_{σ1} as support, the primary current is given by 0 rises sharply, and when t=t₃, reaches the load current refraction value I₁=I₀′. The time-sharing structure is shown in FIGS. 5-3. Then the excitation current I_{M} appears, I₁=I₀′+I_{M}, which generates mutual inductance potential and can overcome the voltage drop of the rectifier and line until matching the remaining voltage of the energy storage capacitor C_{S} in the discharge state, so as to achieve voltage balance and magnetic potential balance

$$\frac{V 1}{V 2} = \frac{N 1}{N 2}$$

on both sides of the transformer

$${I}_{0} ’ = \frac{N 2}{N 1} {I}_{0} .$$

The time-sharing structure is shown in FIGS. 5-4. The commutation process of the two arms is an adaptive adjustment process that first establishes the refraction value of the load current, and then provides the excitation current to establish electromagnetic induction and restore the ability to transmit energy. It successfully realizes the seamless soft connection of the current and voltage on both sides and obtains the same phase voltage and current square wave. All this can be seen in FIG. 5 of the nodal waveform.

### 1. Phase Shifted Full Bridge CTC Zero Current Switch Bidirectional Charger

In order to build a bidirectional battery charger, the following operations are performed on the phase-shifted full-bridge TC zero-current switching charger according to the mirror composition rules: with the transformer as the center, the charging side is modified with reference to the discharging side, and the four diodes of the rectifier bridge, D₅, D₆, D₇, D₈ are reversely connected with controllable switches Q₅, Q₆, Q₇, Q₈, and combined to obtain an IGBT full bridge. Transformer primary and secondary coils N₁ and N₂ are placed in two IGBT full bridges to form a Dual Active Bridge. The energy storage capacitors C_{S} and C_{S1} are connected to the outside of the rectifier bridge respectively, and the filter circuits L_{F}C₁ and L_{F1}C₁₁ are connected to the outside of both sides to obtain the DC voltages V₀ and V₀₁ for output. The low-voltage storage system V₀ is connected to the energy storage battery Z₀, and the power supply system bus high voltage V₀₁ is connected to bus voltage battery Z₀₁. So far, a C T C zero-current switch bidirectional charger has been constructed, as shown in FIG. 6. Due to the loss of the voltage drop on the device and the line, the bus voltage of the reverse operation output is lower than the bus voltage of the forward operation input, resulting in a large hysteresis.

### 2. Phase-Shifted Full Bridge T C+T C Zero Current Switch Bidirectional Charger and Active DC Transformer

In order to solve the large hysteresis of the bus voltage during bidirectional operation, it is necessary to design the transformers T₁ and T₁₁ according to the forward step-down and reverse step-up, respectively constitute the T C step-down charger and the T C step-up charger, and make a good topology in series. As two transformer primary coils N₁; N₁₁ should be placed on an identical layer, which is mostly the inner layer, of the two transformers when winding, so as to obtain the impedance per unit value of the leakage inductance L_{σ1} and L_{σ11} of the primary coils of the two transformers. If there is a deviation, the inductance L_{B} can be used to compensate the side with the low leakage inductance, so that the per unit impedance of the leakage inductance of the primary coils of the two transformers is equal. Finally constitute the patent of the present invention, the phase-shifted full-bridge T C+T C zero-current switch bidirectional charger and active DC transformer, see FIG. 7 for details.

### 3. Control Strategy

The phase-shifted full-bridge bidirectional charger follows the control circuit of the original integrated controller, and obtains a total of four sampling parameters: a pair of voltage and current parameters from the bus voltage side and the low-voltage energy storage side. First go through a weak voltage selection circuit, and select the side with the lower voltage per unit value as the charging side. The current is obtained by excluding the negative value and retaining the positive value to obtain the sampling value of the charging side. Finally, compare the voltage and current values of the two selected charging parties with the given value, select a constant voltage or constant current trigger pulse, and send to the primary side in the bidirectional T C+T C charger topology circuit. The dual active bridge gates of the coils N₁ and N₁₁ of the two transformers T₁ and T₁₁ are triggered synchronously, which will automatically ensure that the side with a strong power supply voltage becomes the discharge side.

### BRIEF DESCRIPTION OF THE DRAWINGS

The drawings are used to provide a further understanding of the present invention and constitute a part of the specification. They are used to explain the present invention together with the embodiments of the present invention and do not constitute a limitation of the present invention. In the attached picture:

FIG. 1 is the schematic diagram of the TC zero-current switching battery charger with the previous invention publication No. U.S. Pat. No. 10,050,544B2.

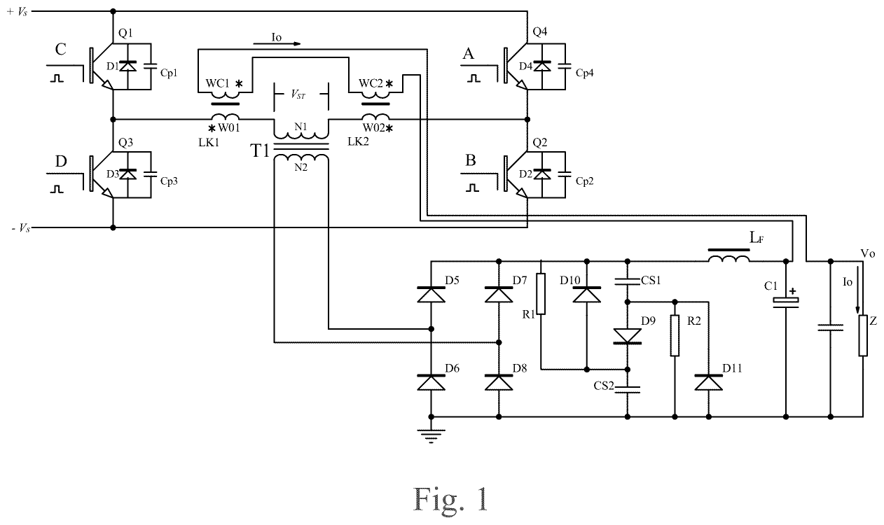

FIG. 2 is the equivalent circuit diagram of the zero-current switching battery charger supported by the previous invention patent.

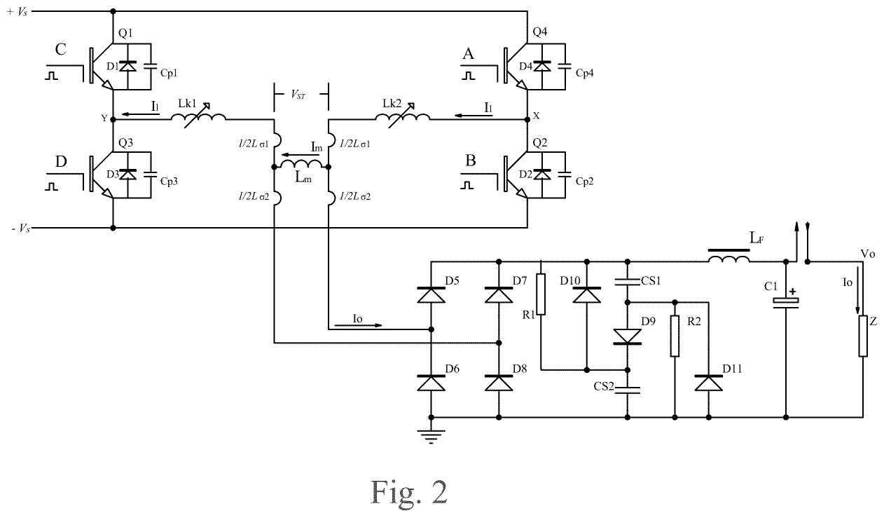

FIG. 3 is the node waveform diagram of the zero-current switching battery charger supported by the previous invention patent.

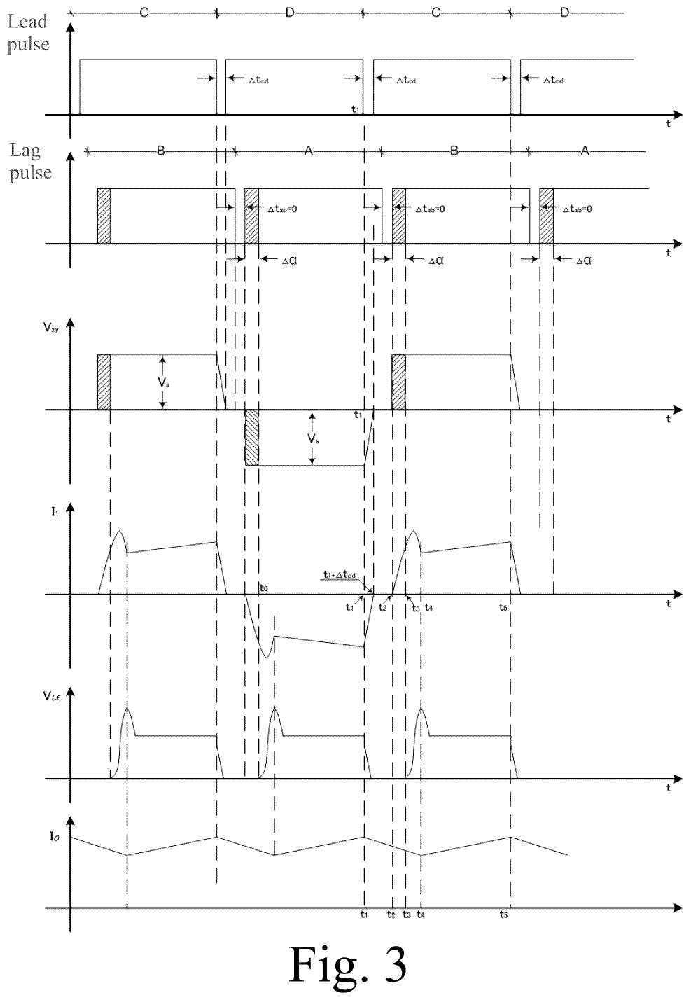

FIG. 4 is a schematic diagram of the phase shifted full bridge TC zero-current switching battery charger of the present invention.

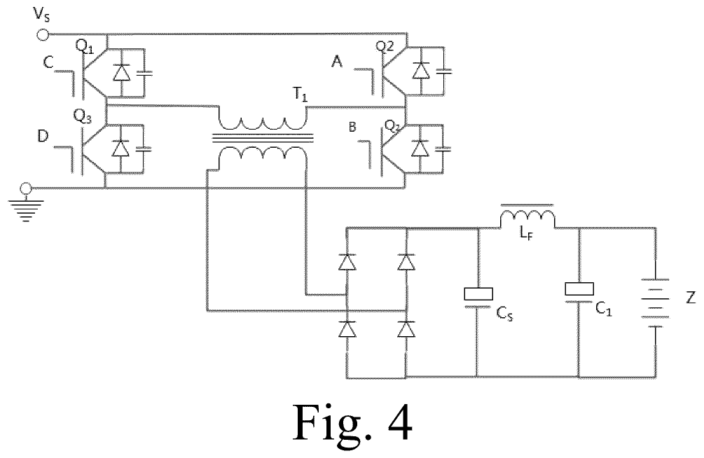

FIG. 5 is a node waveform diagram of the phase shifted full bridge TC zero-current switch bidirectional charger of the present invention.

FIG. 5-1 is a circuit diagram of normal energy transmission under electromagnetic induction at time t₀-t₁ in FIG. 5.

FIG. 5-2 is a circuit diagram of the time division t₁-t₂ in FIG. 5, when the super forearm commutation stops energy transmission and establishes the trailing edge of the current on the primary side.

FIG. 5-3 is a circuit diagram of the time division t₂-t₃ in FIG. 5, when the voltage is applied in the reverse direction by the transformer to establish the current front.

FIG. 5-4 is a circuit diagram that restores electromagnetic induction and continues to transmit energy at time t₃-t₅ in FIG. 5.

FIG. 6 is a schematic diagram of the phase shifted full bridge CTC zero-current switch bidirectional battery charger of the present invention.

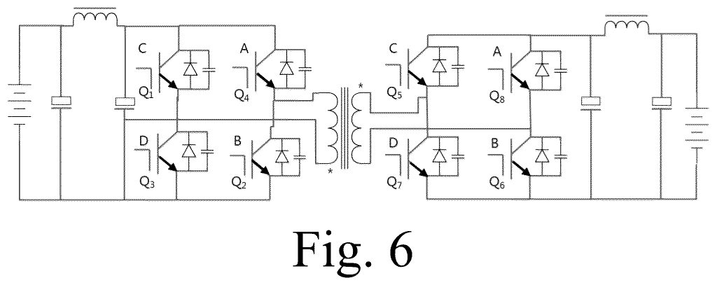

FIG. 7 is a schematic diagram of the TC+TC zero-current switching bidirectional charger and active DC transformer of the present invention.

### DETAILED DESCRIPTION OF THE PREFERRED EMBODIMENT

### 1. KCG3-15A/E395V-3φ480V, Phase-Shifted Full-Bridge T C Zero-Current Commutation, Seamlessly Connected to Soft-Switching Battery Charger.

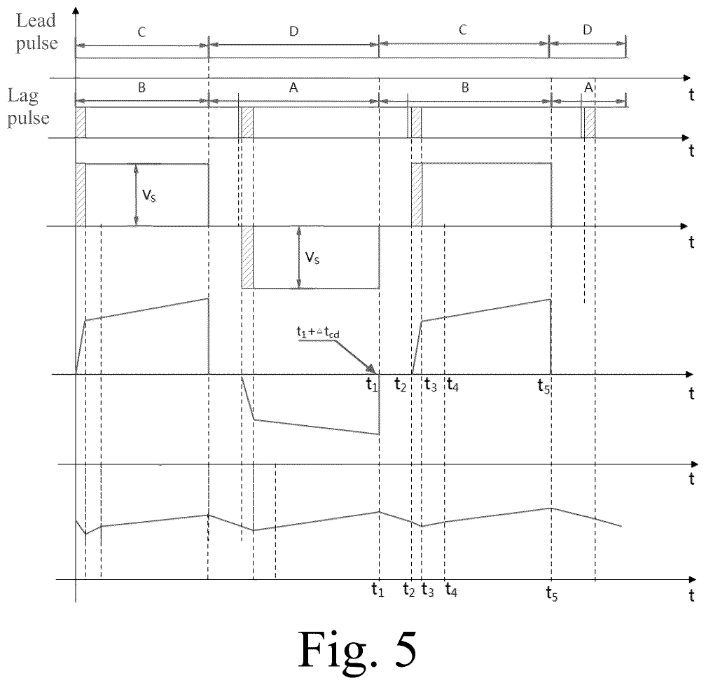

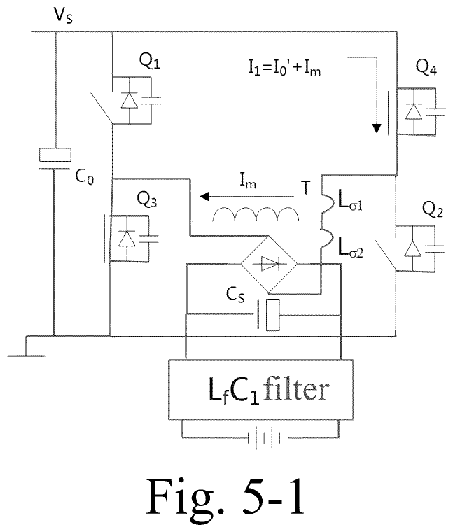

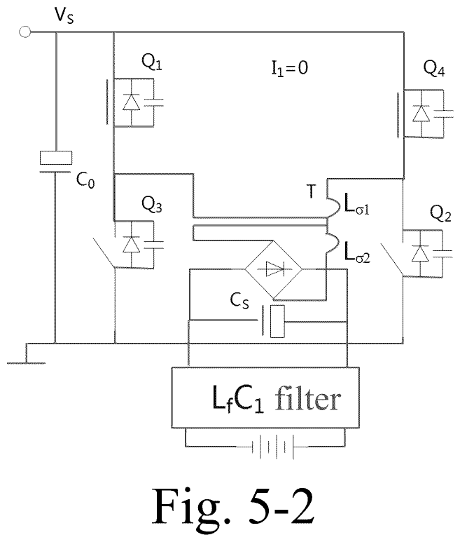

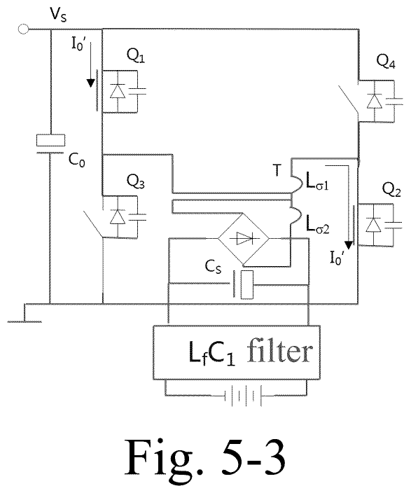

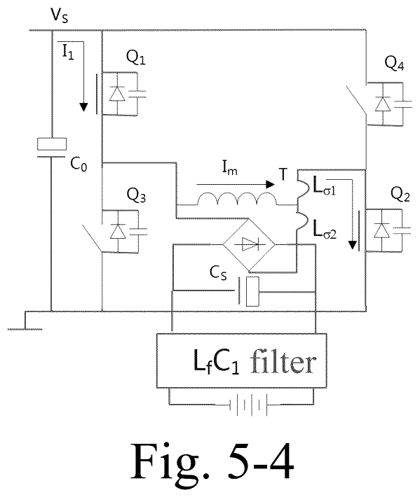

It is used as a tractor battery charger for an airline. This patented technology is used to cancel the original patented controllable saturation inductor L_{K}=L_{K1}+L_{K2} and add a 16 uh inductor to compensate for the original leakage inductance of the transformer of 10 uh. The total leakage inductance is L_{σ1}=26 uh. The bridge rectifier is connected to C_{S}=150uF/800V film capacitor to be used as the energy storage capacitor CS, and then connected to the LC inductor and capacitor filter circuit as usual to form a τ-shaped filter, and 28 12V batteries are connected to form a phase-shifted full bridge TC zero current commutation. Seamless soft-switching battery charger relies on the ability to adaptively restore energy transfer to complete the seamless soft connection of current and voltage on both sides of the transformer. Use an oscilloscope to test the load voltage V_{XY} and current i1 waveform at the midpoint of both arms of the IGBT, see 5-2 and 5-4 of the waveform diagram in FIG. 5.

### 1, High Power Density Phase Shift Full Bridge T C Zero Current Switch Battery Charger

High power density is an important indicator for measuring high-power converters. The improvement of operating frequency is the key. The operating frequency of the previous patent is 25 KHZ, the single unit capacity is 30 KW, and the power density is 1 Kg/KW. Through processing topology on the main circuit in the former patent, the controllable saturation inductance L_{K}=L_{K1}+L_{K2} is cancelled. Due to process limitations, it is impossible to realize that the leakage inductance L_{σ1} of the main transformer is large enough. When t=t₃, the load current refraction value I₁=I₀′ must be reached, and the self-adaptive restoring energy transmit capability is obtained, so that the seamless soft connection of current and voltage on both sides of the transformer can be completed at one time. Add a compensation inductor in series with the leakage inductance L_{σ1} to achieve a large enough level. Add a compensation inductor in series with the leakage inductance L_{σ1}. Now the understanding of the concept of energy transfer on both sides of the self-adaptive recovery transformer has been certified in the following product of KCG3-15A/E385V-3φ480V.

This product is a battery charger recently provided to an airline. It applies the present patented technology. Because the output rated voltage is 385V when debugging, it can start smoothly regardless of the battery load or resistive load. The load fully proves the concept of the self-adaptive recovery transformer transferring energy on both sides is correct.

### 2. 15 KW Phase Shift Full Bridge T C+T C Zero Current Switch Bidirectional Charger and Active DC Transformer

BKCG3-250A/E60V-280V
BKCG3—Zero current switching bidirectional charger
250A—Rated charging current of low-voltage energy storage side
E60V—Average charging voltage rating of low-voltage energy storage side
380V—Bus side rated high voltage

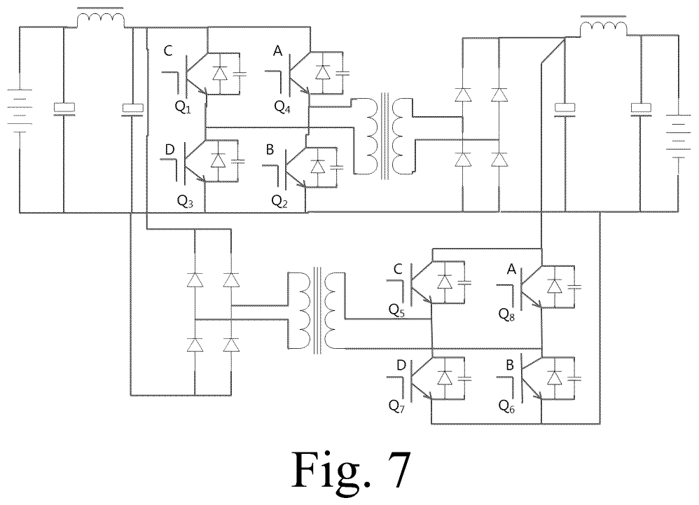

According to content 3 and 4 of this patent invention, transformers T1 and T11 are designed and constitute a phase-shifted full-bridge TC+TC non-hysteresis bidirectional charger, see schematic diagram FIG. 7. In the picture, Z0 uses a 48V/300AH supercapacitor and Z01 uses a 380V equivalent battery.

Startup: In the shutdown state, the energy storage capacitors C_{S} and C_{S1} on both sides are charged to the power supply voltage on their respective sides. If the bus voltage V_{S1} per unit is higher than the energy storage side voltage V_{S} per unit. After starting the operation, the lagging arms of the dual active bridges on both sides receive the trigger signal synchronously. When t=t₃, the bus side must first reach the load current refraction value I₁=I₀′, provide the excitation current, and obtain the ability to adaptively recover and transmit energy, the seamless soft connection of current and voltage on both sides of the transformer is completed in one go. On the secondary side, the induced voltage and current are seamlessly connected to the voltage and current existing in the energy storage capacitor C_{S}. After passing through the filter inductor and capacitor L_{F}C₁ filter circuit, it enters constant current limit charging and gradually increases the battery voltage on the charging side to complete the startup.

Switch charging direction: Affected by external factors, the charging side increases energy and voltage increases, for example, electric vehicles go downhill or elevators go down, and under the influence of negative feedback, the phase shift angle is first reduced to 0, the current drops to 0, and there is no energy exchange. As the energy of the charging side continues to increase, the voltage is higher than that of the original discharging side, and the current reverse energy is sent back as the current reverses, and the phase shift angle is increased to create a new balance between the charging side and the discharging side. Stable in the current-limiting braking state, and complete the switching of the charging direction.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A phase-shifted full-bridge TC zero-current commutation, seamless connection with soft-switching battery charger, wherein the phase-shifted full-bridge battery charger bases on the patent number U.S. Pat. No. 10,050,544B2 and cancels the controllable inductor L_{K}, at the rectifier outlet, an energy storage capacitor Cs is installed to replace the buffer circuit C_{DR} and reconnect with the original inductor-capacitor filter circuit L_{F}C₁, comprising a τ-shaped filter circuit connected to a low-voltage small busbar battery Z_{O}, wherein the energy storage capacitor C_{S} uses a film capacitor, and the capacity is selected according to the fact that the reduction in discharge voltage in one cycle is not be greater than 1%, a difference between the leakage inductance of the transformer and the magnetizing inductance L_{M} of the respective transformer is 10⁻³ times.

2. The phase-shifted full-bridge TC charger as recited in claim 1, wherein the phase-shifted full-bridge TC charger is centered on transformer T₁, symmetrical to Q₁Q₂, Q₃Q₄ to form Q₅Q₆ Q₇Q₈ bridge, forming a dual active bridge, symmetrical to the energy storage capacitor C_{S}, the inductor-capacitor filter circuit L_{F}C₁, and the load battery pack Z₀, set C_{S1}, L_{F1}C₁₁, Z₀₁, constituting a phase-shifted full-bridge CTC zero-current commutation and seamless soft-switching bidirectional charger, parameters on both sides: transformer leakage inductance L_{σ1} and L_{σ2} energy storage capacitors C_{S} and C_{S1}, inductor capacitor filter circuit L_{F}C₁, and L_{F1}C₁₁, the unit value must is equal.

3. The phase-shifted full-bridge TC charger as recited in claim 1, wherein two TC chargers are connected in series, one is connected to the step-down transformer T₁, and the other is connected to the step-up transformer T₁₁, the step-down is designed according to the conditions that the input voltage is the bus rated voltage V_{S1} and the output voltage is the battery average charging voltage V₀, the transformer T₁ is designed according to the safe discharge voltage of the battery as input and the rated bus voltage V_{S1} as the output, the step-up transformer T₁₁ is designed to form a phase-shifted full bridge TC+TC zero-current commutation and seamless soft-switching bidirectional non-hysteresis charger.

4. The bidirectional non-hysteresis charger as recited in claim 3, wherein both the step-down transformer T₁ and the step-up transformer T₁₁ adopt magnetic cores made of highly permeable material, and the primary coils N₁ and N₁₁ are placed on the same side of the transformer, at the level of the coil, the winding method is used to control the leakage inductance, the leakage inductances L_{σ1} and L_{σ11} of the primary coils of the step-down transformer T₁ and the step-up transformer T₁₁ strive to have the same impedance per unit value, which is 10⁻³ times the difference between the magnetizing inductance L_{M} of the respective transformers.

5. The charger as recited in claim 1, wherein the TC charger CTC and the TC+TC bidirectional charger only use a set of phase-shifted full-bridge triggers to trigger the bridge circuit or bidirectional synchronous triggering.

6. The charger as recited in claim 2, wherein the TC charger CTC and the TC+TC bidirectional charger only use a set of phase-shifted full-bridge triggers to trigger the bridge circuit or bidirectional synchronous triggering.

7. The charger as recited in claim 3, wherein the TC charger CTC and the TC+TC bidirectional charger only use a set of phase-shifted full-bridge triggers to trigger the bridge circuit or bidirectional synchronous triggering.
